(19) United States
(12) Patent Application Publication
(10) Pub. No.: US 2025/0174768 A1
(43) Pub. Date: May 29, 2025

(54) BATTERY MODULE WITH AT LEAST ONE ACCUMULATOR COMPRISING A PHASE-CHANGE METAL POWDER FOR LIMITING THE PROPAGATION OF THERMAL RUNAWAY AND THE ASSOCIATED PRESSURE RISE

(71) Applicant: COMMISSARIAT A L'ENERGIE ATOMIQUE ET AUX ENERGIES ALTERNATIVES, Paris (FR)

(72) Inventors: Remi VINCENT, GRENOBLE (FR); Jerome COGNARD, GRENOBLE (FR)

(21) Appl. No.: 18/960,742

(22) Filed: Nov. 26, 2024

(30) Foreign Application Priority Data
Nov. 28, 2023 (FR) 2313166

(51) Int. Cl. H01M 10/659; H01M 10/643

(52) U.S. Cl. CPC H01M 10/659; H01M 10/643

(57) ABSTRACT

Battery module with at least one accumulator including a phase-change metal powder to limit the propagation of thermal runaway and the associated pressure rise. A battery module (M) including at least one phase-change metal powder (10), placed in at least one area intended for the passage of hot gases released by one of the accumulators during thermal runaway, the powder being suitable for changing phase in the area and thus limiting thermal convection of the released hot gases.

### TECHNICAL FIELD

The present invention relates to the field of electrochemical accumulators, and more particularly to metal-ion accumulators.

More particularly, the invention relates to a multilayer film for application to a busbar in a battery module.

It is recalled here that a busbar is a strip (foil) or bar of electrically conductive material, optionally laminated with one or more electrically insulating materials, which is attached, preferably screwed or welded, to an output terminal of at least one electrochemical accumulator to ensure electrical connection with another electrochemical accumulator of a battery pack or another electrical input/output element.

The main aim of the invention is to optimize the cooling of the accumulators in a battery pack, so that the thermal runaway energy of a given accumulator within the pack cannot spread to the other accumulators.

Although described with reference to a lithium-ion accumulator, the invention is applicable to any metal-ion electrochemical accumulator, i.e. also sodium-ion, magnesium-ion, aluminum-ion accumulators, etc., or more generally to any electrochemical accumulator.

A battery pack according to the invention may be on-board or stationary. For example, the fields of electric and hybrid transport and grid-connected storage systems may be envisaged within the context of the invention.

### PRIOR ART

As illustrated schematically in FIGS. 1 and 2, a lithium-ion battery or accumulator usually includes at least one electrochemical cell constituted of an electrolyte constituent 1, between a positive electrode or cathode 2 and a negative electrode or anode 3, a current collector 4 connected to the cathode 2, a current collector 5 connected to the anode 3 and, finally, a packaging 6 arranged to contain the electrochemical cell with leaktightness, while at the same time being traversed by a portion of the current collectors 4, 5.

Conventional lithium-ion battery architecture includes an anode, a cathode and an electrolyte. Several types of conventional architecture geometry are known:
cylindrical geometry, as disclosed in patent application US 2006/0121348,
prismatic geometry, as disclosed in U.S. Pat. Nos. 7,348,098 and 7,338,733,
a stacked geometry, as disclosed in patent applications US 2008/060189 and US 2008/0057392 and U.S. Pat. No. 7,335,448.

The electrolyte constituent 1 may be of solid, liquid or gel form. In the latter form, the constituent may comprise a separator made of polymer, ceramic or microporous composite soaked with organic electrolyte(s) or electrolyte(s) of ionic liquid type, which allows movement of the lithium ion from the cathode to the anode during charging and conversely during discharging, which generates the current. The electrolyte is generally a mixture of organic solvents, for example carbonates, to which is added a lithium salt, typically LiPF6. The positive electrode or cathode 2 is constituted of lithium cation insertion materials, which are generally composite materials, such as LiFePO₄, LiCoO₂ or LiNi_{0.33}Mn_{0.33}Co_{0.33}O₂.

The negative electrode or anode 3 is very often constituted of graphite carbon or of Li₄TiO₅O₁₂ (titanate material), also optionally based on silicon or a silicon-based formed composite.

The current collector 4 connected to the positive electrode is generally made of aluminum.

The current collector 5 connected to the negative electrode is generally made of copper, nickel-treated copper or aluminum.

A lithium-ion battery or accumulator may, obviously, include a plurality of electrochemical cells that are stacked on top of each other.

Conventionally, an Li-ion battery or accumulator uses a couple of materials at the anode and at the cathode, allowing it to function at a high voltage level, typically equal to 3.6 volts.

Depending on the type of application targeted, the aim is to produce either a thin, flexible lithium-ion accumulator or a rigid accumulator: the packaging is then either flexible or rigid, and in the latter case constitutes a kind of casing.

Flexible packagings are usually manufactured from a multilayer composite material constituted of a stack of aluminum layers covered with one or polymer films laminated by bonding.

Rigid packagings are, for their part, used when the intended applications are constraining, in which a long service life is sought, for example with much higher pressures to be withstood and a more rigorous level of leaktightness required, typically less than 10⁻⁸ mbar·l/s, or in media with high constraints, such as the aeronautical or space sector.

Thus, to date, a rigid packaging used is formed from a metal casing, typically made of stainless steel (inox 316L or inox 304) or of aluminum (Al 1050 or Al 3003), or else of titanium.

The geometry of most rigid Li-ion battery packaging casings is cylindrical, as most of the accumulator's electrochemical cells are wound in a cylindrical geometry around a cylindrical mandrel. Prismatic casing shapes have also already been produced by winding around a prismatic mandrel, or by stacking electrochemical cells.

Patent application FR3004292 describes the use of the mandrel inner as an air knife for core cooling of a wound cell of a metal-ion accumulator.

One type of rigid, cylindrical casing, usually manufactured for a high-capacity Li-ion accumulator, is illustrated in FIG. 3.

A rigid prismatic casing is also shown in FIG. 4.

The casing 6 includes a cylindrical lateral envelope 7, a base 8 at one end, a cover 9 at the other end, the base 8 and cover 9 being joined to the envelope 7. The cover 9 supports the current output poles or terminals 4, 5. One of the output terminals (poles), for example the negative terminal 5, is welded to the cover 9, while the other output terminal, for example the positive terminal 4, passes through the cover 9 with the interposition of a seal not shown, which electrically isolates the positive terminal 4 from the cover.

The type of rigid casing widely manufactured also consists of a deep-drawn cup and a cover, welded together around their periphery. Current collectors, on the other hand, comprise a feedthrough with a part of the casing protruding from the top, forming a terminal also known as the visible pole of the battery.

A battery pack P is formed from a variable number of accumulators, up to several thousand in number, which are electrically connected in series or parallel with each other, generally via connecting bars, usually referred to as busbars.

An example of a battery pack P is shown in FIG. 5. This pack is constituted of two identical Li-ion A accumulator modules M1, M2 connected together in series, each module M1, M2 consisting of four rows of accumulators connected in parallel, each row consisting of an equal number of six Li-ion accumulators.

As shown, the mechanical and electrical connection between two Li-ion accumulators of the same row is achieved by screwing on busbars B1, advantageously made of copper, each connecting a positive terminal 4 to a negative terminal 5. The connection between two parallel rows of accumulators within the same module M1 or M2 is provided by a busbar B2, also advantageously made of copper. The connection between the two modules M1, M2 is provided by a busbar B3, also advantageously made of copper.

In the development and manufacture of lithium-ion batteries, for each profile/new application, irrespective of the market players involved, precise dimensioning is required (serial/parallel electrical, mechanical, thermal architectures, etc.) to optimally design a safe and efficient battery pack.

In particular, the safety of lithium-ion accumulators must be considered at the level of a single accumulator, a module and also a battery pack.

Various passive or active agents with a safety function may also be incorporated into a cell (accumulator), and/or a module and/or the battery pack, to prevent problems when the battery is subjected to “abusive” operating conditions.

A lithium electrochemical system, whether at cell (accumulator), module or pack level, produces exothermic reactions irrespective of the given cycling profile. Thus, at the level of a single accumulator, depending on the chemistries considered, the optimum operation of lithium-ion batteries is limited to a certain temperature range.

An electrochemical accumulator must operate within a defined temperature range, typically below 70° C. at its casing outer surface, otherwise its performance will be degraded, or it will even be physically damaged to the point of destruction.

Mention may be made, for example, of lithium accumulators with iron-phosphate chemistry, which generally have an operating range of between −20° C. and +60° C. Above 60° C., the materials may undergo significant degradation, reducing cell performance. Above a “thermal runaway” temperature, which may be between 70° C. and 110° C., exothermic internal chemical reactions are triggered. When the accumulator is no longer able to dissipate sufficient heat, the temperature of the electrochemical cell rises to the point of destruction, this phenomenon commonly being referred to as “thermal runaway”.

In other words, thermal runaway occurs in a cell (accumulator) when the energy released by exothermic reactions inside the cell exceeds its capacity to dissipate this energy to the outside. This runaway may be followed by gas generation, explosion and/or fire.

Furthermore, maintaining a temperature below 70° C. allows an accumulator's service life to be extended, since the higher the operating temperature of an accumulator, the more its service life will be reduced.

In addition, some accumulator chemistries require an operating temperature well above room temperature, and consequently it is necessary to regulate their temperature level by initial preheating of the accumulators, or even by permanently maintaining the temperature of the accumulators.

For reasons of volumetric compactness, it has been chosen to use assemblies of X accumulators in series and Y in parallel. The mechanical integration of accumulators of cylindrical geometry with a rigid casing 6 within a module or battery pack is widely chosen, as illustrated in FIG. 6.

In this integration, the accumulators A1, A2 . . . . A42 are arranged parallel to each other, in contact with each other via their casing 6, and staggered to form a matrix extending in the Z direction. A staggered arrangement allows high energy density.

This matrix is usually assembled by adhesively bonding the accumulators A1, A2 . . . . A42 to each other.

In the context of an operational risk analysis study, the inventors highlighted that one of the most critical risks for a module such as the one shown in FIG. 6 was the internal short-circuiting of an accumulator, following a manufacturing defect (with a failure rate of 10⁻⁷/h).

Thus, when a fault of this type is declared, as already mentioned above, thermal runaway of an accumulator within the module may occur. Following this runaway of an individual accumulator, it may spread to adjacent accumulators within a module.

It is therefore important to implement a mitigating solution that eliminates the risk of propagation in the event of accidental runaway of an accumulator, and that also limits any propagation outside the module, in particular via the expulsion of flames or incandescent particles.

However, not all the cooling devices existing in the prior art allow for the effective mitigation of thermal runaway of an accumulator within a battery pack, i.e. to attenuate the transmission of the energy dissipated by thermal runaway of the accumulator to the other accumulators in the pack, so as to prevent them also from entering a thermal runaway situation.

Patent application WO 2022/090575 A1 proposed a multilayer film, arranged in the predetermined path of hot gases released under pressure in the event of thermal runaway of one of the accumulators in a battery module, whose aqueous gel layer facing the accumulators allows the propagation of thermal runaway from one of them to the others to be limited. This multilayer film solution including an aqueous gel layer is satisfactory insofar as it effectively cools hot gases and is also optimized in terms of weight and size to preserve pack performance. It does, however, have the drawback of being liable, in certain configurations, to contribute to pressure rise through its phase change in the module casing.

There is thus a need to improve the solutions for mitigating thermal runaway of any accumulator within a module or battery pack, which does not increase the pressure.

In addition, the improvement also needs to be optimized in terms of weight and size to preserve the performance of the module or battery pack.

The aim of the invention is to at least partly meet this or these need(s).

### DISCLOSURE OF THE INVENTION

To this end, one aspect of the invention relates to a battery module comprising:
a plurality of accumulators each comprising at least one electrochemical cell formed of a cathode, an anode and an electrolyte interposed between the cathode and the anode, a casing arranged to contain the electrochemical cell in a leaktight manner and two output terminals projecting from the lid and/or bottom of the casing;
preferably at least one busbar attached to one of the output terminals of at least some of the accumulators, so as to electrically interconnect them;
at least one phase-change metal powder, placed in at least one area intended for the passage of hot gases released by one of the accumulators during thermal runaway, the powder being suitable for changing phase in the area and thus limiting thermal convection of the released hot gases.

Preferably, at least some of the powder is deposited on the busbar.

Preferably, the phase-change metal powder material is suitable for changing phase at a temperature of between 150 and 700° C., preferably between 25° and 500° C.

Advantageously, the phase-change material of the metal powder is chosen from potassium fluoroborate (KBF₄), potassium magnesium chloride (KMgCl₃), NaKMgCl, KMgZnCl or a mixture thereof.

The accumulators may be cylindrical in geometry.

According to an advantageous embodiment, the module comprises at least one leaktightness means between the accumulators and the area intended for the passage of hot gases released by one of the accumulators during thermal runaway.

According to this embodiment and an advantageous configuration, the module comprises a casing, known as a battery casing, housing the cylindrical accumulators and a leaktight retaining plate, as a leaktightness means, which holds the cylindrical accumulators in the battery casing and maintains the leaktightness between one of their terminals, notably their positive terminals, electrically connected in series and/or parallel, and the rest of the cylindrical accumulators, the powder at least partly filling the volume delimited between the battery casing and the leaktight retaining plate containing the connected terminals.

The powder grains may be loose or agglomerated.

According to an advantageous variant, prior to its insertion, the powder is compacted under pressure or agglomerated with a polymeric binder, preferably chosen from carboxymethylcellulose (CMC) or polyvinyl acetate (PVAC).

Advantageously, the thickness of the deposited metal powder is between 10 and 50 mm.

According to an advantageous embodiment variant, the metal powder is encapsulated between two encapsulation films or in an encapsulation envelope closed by a film. These encapsulation envelopes and films prevent the powder from flowing over time, or from undergoing any vibrations to which the battery module may be subjected.

Preferably, one of the two encapsulation films is intended for direct application to the busbar.

In order to allow good gas evacuation, one encapsulation film is configured to deteriorate when an accumulator vent is opened and electrolyte is optionally ejected. Thus, advantageously, one and/or other of the encapsulation films is/are made of a polymer chosen from polyethylene (PE) or polyether.

The thickness of each encapsulation film is preferably not more than 50 μm.

The invention thus consists essentially of a phase-change metal powder arranged in the predetermined path of hot gases released under pressure in the event of thermal runaway of one of the accumulators in a battery module.

By virtue of its phase change, the powder facing the accumulators will limit the effect of thermal convection when incandescent gases are released from an accumulator and by thermal conduction notably via a busbar, and thus prevent the propagation of thermal runaway from one of these accumulators to the others.

Thus, in the event of thermal runaway of one of the accumulators, which may be denoted as a “trigger accumulator”, the local melting of the powder allows the temperature rise of neighboring accumulators to be significantly limited.

The first function of the powder is to form a real thermal barrier protecting the other accumulators, i.e. those not in runaway mode, by preventing the hot gases released by the trigger accumulator's safety vent(s) from heating up the other accumulators very strongly.

The area(s) through which the hot gases released during thermal runaway of one of the accumulators in the module (M) pass are determined in advance.

During thermal runaway, the powder may advantageously allow the separation of hot gases venting from the trigger accumulator from the rest of the accumulators, by forming a thermal barrier limiting heat exchange between the vent gases that have passed through the powder and the accumulators.

Hot gases may pass through the powder, which then changes phase.

At least one of the accumulators, preferably each accumulator, may comprise at least one safety vent configured to release hot gases under pressure in the event of thermal runaway of said accumulator, with the powder facing the safety vent. Advantageously, such an arrangement allows an increase in the amount of hot gases that can pass through the powder during venting. Advantageously, the powder is arranged as close as possible to the safety vent, or is even deposited thereon.

Preferably, the safety vent(s) are located on one of the output terminals of the accumulator(s), preferably on the positive output terminal. The venting of hot gases may take place through the busbar.

It should be noted here that for the thermal runaway phenomenon, reference is made to publication [2] and to the protocol described therein. The temperatures referred to in this publication as “self-heating” and “thermal runaway” are T1 and T2, respectively.

The temperature T1, typically 70° C., in FIG. 2 of the publication, is the temperature from which the accumulator heats up without an external source at a typical rate of 0.02° C./min under adiabatic conditions.

The temperature T2, typically 150° C., in FIG. 2 of the publication, is the temperature from which the accumulator heats up at a typical heating rate of 10° C./min under adiabatic conditions, leading to the melting of the separator in the accumulator's electrochemical bundle, to a short-circuit and thus to voltage collapse.

The term “thermal runaway” may thus be understood here and in the context of the invention to mean a ratio between the value of the derivative of the heating temperature and that of time at least equal to 0.02° C. per min.

In other words, by virtue of the phase-change powder in accordance with the invention, the thermal runaway energy of the trigger accumulator is not fully transmitted to adjacent accumulators in the pack, thereby limiting their temperature.

Consequently, a powder according to the invention helps to prevent the accumulators adjacent to a trigger accumulator from also going into thermal runaway.

Compared with a known solution using liquid water, use of a phase-change powder according to the invention is simpler. Specifically, it does not require a perfectly leaktight container throughout the runaway of an accumulator. The powder also helps to limit potential short-circuit risks within a battery module.

More generally, the phase-change powder according to the invention differs from prior art solutions in that it actuates at a higher temperature than the materials generally used, due to its phase change, and does not produce additional gas. The increase in volume associated with the powder's phase change from solid to liquid is much lower than with a phase change to gas. The powder thus limits the maximum pressure within a module casing, which is not the case with prior art solutions such as water.

The inventors have overcome a technical prejudice, since until now it was assumed that only materials with a phase change at about 100° C. would enable a trigger accumulator to avoid runaway.

However, by analyzing the types of thermal runaway, the inventors have highlighted that such materials are not really effective for short-circuit faults internal to an accumulator.

This is why the inventors opted for a powder whose phase change takes place at higher temperatures, in order to limit the propagation and amount of gas released in a battery module casing.

Overall, the invention provides numerous advantages, among which may be mentioned:
the powder is simpler to implement than prior art solutions, as it does not require perfectly leaktight solutions throughout the runaway of an accumulator;
limitation of potential short-circuit risks;
a safety solution that is easy to implement and effective in preventing the propagation of thermal runaway within a module or battery pack;
a solution which is not detrimental to the weight of a module or battery pack, as a phase-change powder according to the invention may possibly be very light, which is very advantageous for on-board applications;
the ability to install a phase-change powder very quickly and easily in a module or battery pack, either at the design stage or, on the other hand, as a retrofit to an existing module or battery pack.

For application to an Li-ion battery pack, each accumulator is an Li-ion accumulator in which:
the material of the negative electrode(s) is chosen from the group including graphite, lithium titanate oxide Li₄TiO₅O₁₂;
the material of the positive electrode(s) is chosen from the group including LiFePO₄, LiCoO₂ and LiNi_{0.33}Mn_{0.33}Co_{0.33}O₂.

Other advantages and features of the invention will emerge more clearly on reading the detailed description of examples of implementation of the invention which are given as nonlimiting illustrations in reference to the following figures.

### BRIEF DESCRIPTION OF THE DRAWINGS

FIG. 1 is a schematic exploded perspective view showing the various elements of a lithium-ion accumulator.

FIG. 2 is a front view showing a lithium-ion accumulator with its flexible packaging according to the prior art.

FIG. 3 is a perspective view of a lithium-ion accumulator according to the prior art with its rigid packaging consisting of a cylindrical casing.

FIG. 4 is a perspective view of a lithium-ion accumulator according to the prior art with its rigid packaging consisting of a prismatic casing.

FIG. 5 is a perspective view of a prior art assembly of lithium-ion accumulators using busbars, forming a battery pack.

FIG. 6 is a perspective view of a plurality of lithium-ion accumulators of cylindrical geometry pre-assembled together according to the prior art, forming a matrix intended for a battery module or a battery pack.

FIG. 7 is a side view of a battery module equipped with a busbar on which a phase-change metal powder according to the invention is deposited.

### DETAILED DESCRIPTION

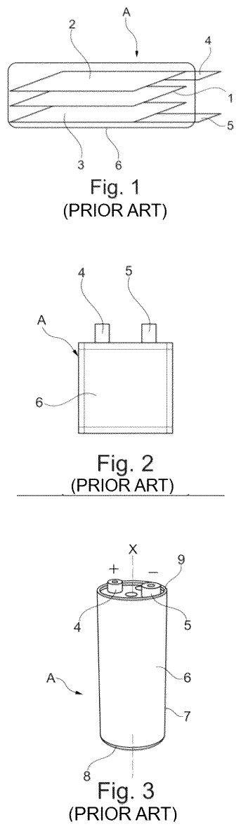

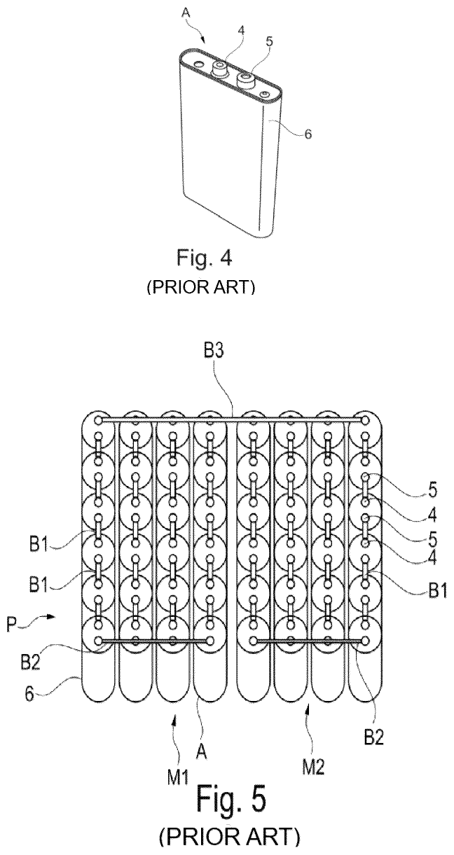

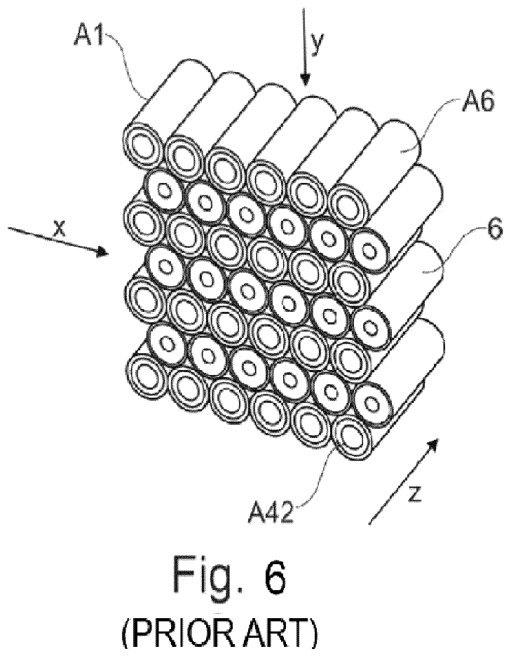

FIGS. 1 to 6 show different examples of Li-ion accumulators, flexible packaging and accumulator casings, and also a battery pack according to the prior art. FIGS. 1 to 6 have already been commented on in the preamble and thus are not commented on any further hereinbelow.

For the sake of clarity, the same references denoting the same elements according to the prior art and according to the invention are used for all the FIGS. 1 to 7.

Throughout the present patent application, the terms “lower”, “upper”, “bottom”, “top”, “under” and “over” are to be understood by reference to vertically arranged Li-ion accumulator casings, i.e. with a multilayer film according to the invention lying horizontally.

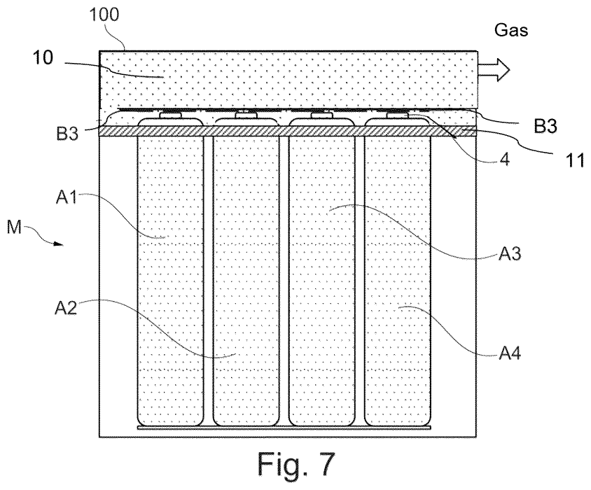

FIG. 7 represents an example of a phase-change metal powder 10 according to the invention deposited on a busbar B3 of a module M of a battery of Li-ion accumulators, A1, A2, A3, A4.

In the examples shown, the accumulators A1-A4 illustrated may have cylindrical casings, typically in 18650 or 21700 format.

The accumulators A1-AA4 are electrically connected by their output terminals in groups via busbar B3.

According to the invention, a phase-change metal powder 10 according to the invention is deposited directly against busbar B3.

The powder 10 is preferably made of KBF₄.

The powder 10 may be encapsulated between two polymer films.

The thickness of each encapsulation film is typically about 50 μm.

The thickness of powder 10 may be between 10 and 50 mm.

As regards the placement of a powder 10 according to the invention within a battery module M, it may be performed in several forms.

A first alternative consists in pouring the powder 10 by gravitational flow so that it settles at least on the busbar B3 of the positive terminals 4.

The powder may at least partially fill a volume between the wall of the module casing 100 and a retaining and leaktightness plate 11, arranged below the busbar B3 and the positive terminals 4, as shown in FIG. 7.

This plate 11 holds the accumulators A1 to A4 and separates the output terminals 4 from the rest of the accumulators in a leaktight manner.

A second alternative consists in encapsulating powder 10 between two encapsulating films, as indicated above, and placing the encapsulated assembly directly in contact with busbar B3.

A third alternative consists in agglomerating powder 10 to form a solid part, notably by compaction under pressure or by premixing with a polymeric binder, such as CMC or PVAC, and then positioning the solid part produced directly in contact with busbar B3.

During thermal runaway of an 18650-size accumulator, about 80 kJ of thermal energy may be released.

Generally speaking, the energy released is divided between the gases and the molten materials ejected, which represent about 70% of the heat, and the energy emitted by the accumulator casing due to the materials used to make the accumulator, which represents the remaining 30% of the heat.

It is thus important to implement a solution for mitigating heat transfer between the accumulators, taking into consideration the thermal convection via the gases and also conduction via the busbars.

As shown schematically in FIG. 7, adding a phase-change powder 10 to a busbar B3, typically connected to the positive terminals 4 of accumulators A1-A4, allows these two modes of heat transfer to be limited. Hot gases from the trigger accumulator are evacuated through its safety vent.

The safety vent of the accumulators may be located on their positive terminal 4. The hot gases evacuated by the safety vent then pass through the busbar B3 and then through the phase-change metal powder 10.

The powder 10 then limits conduction through busbar B3, and also the thermal convection effect of the hot gases on the accumulators adjacent to the trigger accumulator.

In order to validate the safety of the KBF₄ powder according to the invention, the inventors conducted a series of tests.

Each of the tests consisted in placing 18650-type accumulators in a canister simulating a battery module casing, and then allowing the accumulators to go into thermal runaway.

In one test, for comparative purposes, no powder was placed in the canister. In the other test, an amount of KBF₄ powder was added, in accordance with the invention.

Visually, the inventors found that large incandescent flames came out of the canister in the comparative test, whereas no flames came out of the canister containing the KBF₄ powder.

This aspect, i.e. that no flame emerges from a module casing, in the event of thermal runaway, is very important, notably as the new automotive standards will apply additional constraints on the presence of flames outside a battery pack casing.

In addition, in both tests, the pressure and temperature inside the canister were also measured. Table 1 summarizes the measurements taken.

TABLE 1

| | Test | Test |
|---|---|---|
| | without | according to the |
| | KBF₄ | invention, with |
| Test | powder | KBF₄ powder |
| Temperature (° C.) | 1300 | 600 |
| Pressure (bar) | 7.5 | 3.2 |

The results clearly show that the addition of KBF₄ powder reduces both the temperature and the maximum pressure in the canister.

These results are particularly important as the maximum temperature has a direct impact on the risk of thermal runaway propagation, and the pressure is a value directly used for the mechanical sizing of a module or battery pack casing.

Thus, reducing the maximum pressure by addition of KBF₄ powder may lead to mass optimization: the addition of a small mass of KBF₄ powder may lead to the removal of a relatively large mass from a module casing.

The invention is not limited to the examples that have just been described; characteristics of the illustrated examples may notably be combined together within variants not illustrated.

Other variants and improvements may be envisaged without, however, departing from the scope of the invention.

The examples given above relating to the positive pole of the accumulators are also transferable to application on a busbar on the negative pole side.

In the illustrated embodiments, the accumulators are cylindrical, for example of 18650 type, with a safety vent in the positive terminal of each accumulator. Other accumulator forms and/or safety vent arrangements are also possible.

However, gas outlet pressures and temperatures through the vents are such that the phase-change powder according to the invention is chosen not to represent an appreciable barrier to the evacuation of incandescent gases from the accumulator vents.

### LIST OF REFERENCES CITED

[1] https://www.mersen.com/sites/default/files/publications-media/16-markets-transportation-ev-hev-emobility-presentation-mersen.pdf.
[2] Xuning Fenga, et al. “Key Characteristics for Thermal Runaway of Li-ion Batteries” Energy Procedia, 158 (2019) 4684-4689.

1. A battery module comprising:
a plurality of accumulators each comprising at least one electrochemical cell formed of a cathode, an anode and an electrolyte interposed between the cathode and the anode, a casing arranged to contain the electrochemical cell in a leaktight manner and two output terminals projecting from the lid and/or bottom of the casing;
at least one phase-change metal powder, placed in at least one area intended for the passage of hot gases released by one of the accumulators during thermal runaway, the powder being suitable for changing phase in the area and thus limiting thermal convection of the released hot gases, the phase-change material of the metal powder being suitable for phase change at a temperature of between 150 and 700° C. the phase-change material of the metal powder being chosen from potassium fluoroborate (KBF₄), magnesium potassium chloride (KMgCl₃), NaKMgCl, KMgZnCl or a mixture thereof.

2. The battery module as claimed in claim 1, comprising at least one busbar attached to one of the output terminals of at least some of the accumulators, so as to electrically interconnect them.

3. The battery module (M) as claimed in claim 1, wherein at least some of the powder is deposited on the busbar.

4. The battery module as claimed in claim 1, wherein the accumulators have a cylindrical geometry.

5. The battery module as claimed in one of the claim 1, comprising at least one leaktightness means between the accumulators and the area intended for the passage of hot gases released by one of the accumulators during thermal runaway.

6. The battery module as claimed in claim 5, comprising a casing, known as a battery casing, housing the cylindrical accumulators and a leaktight retaining plate, as a leaktightness means, which holds the cylindrical accumulators in the battery casing and ensures the leaktightness between one of their terminals, notably their positive terminals, electrically connected in series and/or parallel, and the rest of the accumulators, the powder at least partly filling the volume delimited between the battery casing and the leaktight retaining plate containing the connected terminals.

7. The battery module as claimed in claim 1, wherein the powder grains are loose or agglomerated.

8. The battery module as claimed in claim 7, wherein the powder, prior to its insertion, is compacted under pressure or agglomerated with a polymeric binder, preferably chosen from carboxymethylcellulose (CMC) or polyvinyl acetate (PVAC).

9. The battery module as claimed in claim 1, wherein the thickness of the metal powder is between 10 and 50 mm.

10. The battery module as claimed in claim 1, wherein the metal powder is encapsulated between two encapsulation films or in an encapsulation envelope closed by a film.

11. The battery module as claimed in claim 10, wherein one and/or other of the encapsulation films is made of a polymer chosen from polyethylene (PE) or polyether.

12. The battery module as claimed in claim 10, wherein the thickness of an encapsulation film being not more than 50 μm.

13. The battery module as claimed in claim 1, wherein each accumulator is an Li-ion accumulator in which:
the material of the negative electrode(s) is chosen from the group including graphite, lithium titanate oxide Li₄TiO₅O₁₂;
the material of the positive electrode(s) is chosen from the group including LiFePO₄, LiCoO₂ and LiNi_{0.33}Mn_{0.33}Co_{0.33}O₂.
